(19) United States
(12) Patent Application Publication
(10) Pub. No.: US 2015/0350444 A1
(43) Pub. Date: Dec. 3, 2015

(54) METHODS AND SYSTEMS FOR PROVIDING A MULTI-CHANNEL CUSTOMER ENGAGEMENT EXPERIENCE

(71) Applicant: CafeX Communications, Ltd., Cardiff (GB)

(72) Inventors: Kevin J. Glass, Cardiff (GB); Dale O'Connor, Cardiff (GB); Gareth Smith, Cardiff (GB); Craig Williams, Cardiff (GB)

(21) Appl. No.: 14/723,640

(22) Filed: May 28, 2015

Related U.S. Application Data
(60) Provisional application No. 62/005,201, filed on May 30, 2014.

(51) Int. Cl. H04M 3/523; H04L 29/08

(52) U.S. Cl. CPC H04M 3/5232; H04L 67/22

(57) ABSTRACT

A multi-channel communication system may include a plurality of agent electronic devices associated with a customer center, and a context electronic device including a processor and a session database. The context electronic device may be communication with each of the plurality of agent electronic devices such that each of the plurality of agent electronic devices is able to access information stored in the session database. The system may include a proxy in communication with one or more user electronic devices and the context electronic device, where the proxy may be configured to route a communication from the user electronic devices to a designated agent electronic device from the plurality of agent electronic devices that is associated with a communication channel, where the communication occurs via the communication channel, and the context electronic device. The context electronic device may be configured to store received context information associated with the communication in the session database.

### RELATED APPLICATIONS AND CLAIMS OF PRIORITY

This patent application claims priority to U.S. Provisional Patent Application No. 62/005,201 filed May 30, 2014, the disclosure of which is fully incorporated herein by reference.

### BACKGROUND

Enterprise Customer Relationship Management (CRM) systems and contact center infrastructures have evolved from providing basic telephone support to environments that are able to provide live chat, co-browsing, screen-sharing, video calls, visual interactive voice response (IVR) and/or the like.

Given the evolutionary nature of these services and the investments made in technology choices, the overall customer experience is typically serviced by multiple discrete communication channels. These communication channels are sometimes provided by a variety of solution providers, or provided by a common solution provider, but as discrete communication channels. The result is often a broken customer experience where customers must frequently reestablish their credentials and reassert their issues as they are transferred between the communication channels.

For example, live chat services may be provided by a different infrastructure provider than a core contact center telephony service. If a customer needs to talk to an agent to resolve a problem, the customer is typically connected to a contact center agent who has no awareness of the live chat session that has taken place. As such, the customer may be asked to reconfirm his or her details and repeat the problem for the agent.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. As used herein, the term “comprising” means “including, but not limited to.”

In an embodiment, a multi-channel communication system may include a plurality of agent electronic devices associated with a customer center, and a context electronic device including a processor and a session database. The context electronic device may be communication with each of the plurality of agent electronic devices such that each of the plurality of agent electronic devices is able to access information stored in the session database. The system may include a proxy in communication with one or more user electronic devices and the context electronic device, where the proxy may be configured to route a communication from the user electronic devices to a designated agent electronic device from the plurality of agent electronic devices that is associated with a communication channel, where the communication occurs via the communication channel, and the context electronic device. The context electronic device may be configured to store received context information associated with the communication in the session database.

### BRIEF DESCRIPTION OF THE DRAWINGS

FIG. 1 illustrates an example multi-channel communication system according to an embodiment.

FIG. 2 illustrates an example method of communication with a multi-channel communication system according to an embodiment.

FIG. 3 illustrates a block diagram of example hardware that may be used to contain or implement program instructions according to an embodiment.

### DETAILED DESCRIPTION

The following terms shall have, for purposes of this application, the respective meanings set forth below:

An “agent” refers to a representative of contact center who interfaces with a customer or other user about user communications such as, for example, customer inquiries.

A “communication channel” refers to any transmission medium that facilitates or permits communication between a user, such as a customer, and an agent, a contact center and/or the like.

A “computing device” or “electronic device” refers to a device that includes a processor and non-transitory, computer-readable storage medium, such as, for example, memory. The computer-readable storage medium may contain programming instructions that, when executed by the processor, cause the computing device to perform one or more operations according to the programming instructions. As used in this description, a “computing device”, “electronic device” or “processor” may be a single device, or any number of devices having one or more processors that communicate with each other and share data and/or instructions. Examples of computing devices or electronic devices include, without limitation, personal computers, servers, mainframes, gaming systems, televisions, and portable electronic devices such as smartphones, personal digital assistants, cameras, tablet computers, laptop computers, media players and the like.

A “contact center” refers to a central point or location, physical or virtual, from which customer contacts are managed. A customer contact center may be associated with an organization, a business and/or other entity that provides goods or services. For instance, a customer contact center may be a point of contact for customer inquiries about purchased goods or services. In other embodiments, a customer contact center may be a point of contact for other types of customer support such as, for example, technical support, general inquiries and/or the like.

“Context information” refers to information relating to one or more communications between a user and a contact center, contact center representative and/or agent.

A “database” is a set of one or more non-transitory, computer readable memories or memory sectors or portions on which computer-readable data is stored.

The terms “memory,” “computer-readable medium” and “database” each refer to a non-transitory device on which computer-readable data, programming instructions or both are stored. Unless the context specifically states that a single device is required or that multiple devices are required, the terms “memory,” “computer-readable medium” and “database” include both the singular and plural embodiments, as well as portions of such devices such as memory sectors.

A “multi-channel communication system” refers to a communication system that utilizes two or more different communication channels.

A “processor” is a component of an electronic device that executes programming instructions. The term “processor” may refer to either a single processor or to multiple processors that together implement various steps of a process. Unless the context specifically states that a single processor is required or that multiple processors are required, the term “processor” includes both the singular and plural embodiments.

A “web application” is a set of programming instructions that, when executed by processor of an electronic device, retrieves information from a web service and presents the retrieved information to a user of the electronic device. A browser is an example of a client application. Example types of information that a client application may retrieve include a web page, an electronic file, an image or other data.

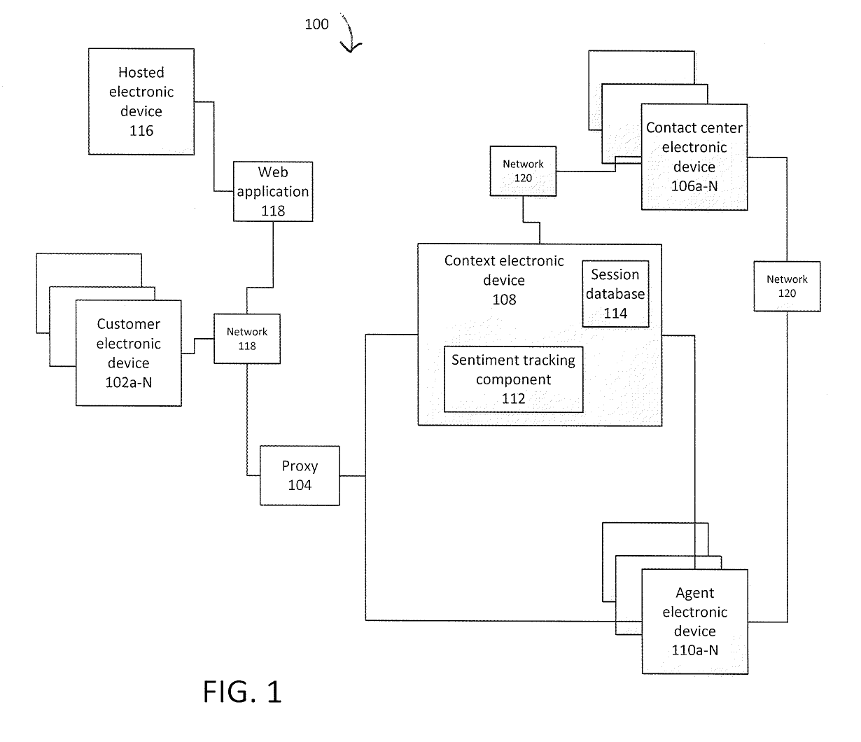

FIG. 1 illustrates an example multi-channel communication system according to an embodiment. As illustrated by FIG. 1, the system 100 may include one or more user electronic devices 102a-N, a proxy 104, a contact center electronic device 106a-N, a context electronic device 108, and one or more agent electronic devices 110a-N.

In an embodiment, a user electronic device 102a-N may be used by a user, such as a customer, to initiate communication with a customer contact center via a communication channel. A communication channel may be a phone call, an audio and/or video chat session, a social media post, an email, a text message and/or the like.

In an embodiment, a user electronic device 102a-N may be in communication with one or more agent electronic devices 110a-N via a communication network 118. A communication network 114 may be a local area network (LAN), a wide area network (WAN), a mobile or cellular communication network, an extranet, an intranet, the Internet and/or the like. In an embodiment, an agent electronic device 110a-N may be associated with a support agent who is handling a customer interaction. A support agent may be associated with one or more communication channels. For instance, an agent may handle chat communications, while another agent may handle phone communications.

In an embodiment, a proxy 104 may route one or more communications, or copies of one or more communications to a context electronic device 108. As such, a user-initiated communication may be sent to a context electronic device 108 and an appropriate agent electronic device. A proxy 104 may be an electronic device, such as, for example, a proxy server. Or, in another embodiment, a proxy 104 may be a set of programming instructions that, when executed by a processor of an electronic device, routes communications from one or more user electronic devices to one or more other electronic devices.

A context electronic device 108 may monitor, track and/or store information pertaining to one or more user communications and/or communications sessions such as, for example, context information. A context electronic device 108 may maintain a session database 114 that tracks information pertaining to users, user electronic devices, context information and/or other information relating to communications as discussed in more detail below. In an embodiment, a contact center electronic device 106a-N and/or one or more agent electronic devices may be in communication with a context electronic device 108 over one or more communication networks 120, and may be able to access information from the session database 114.

In an embodiment, a context electronic device 108 may include a sentiment tracking application 112 for performing sentiment analysis. In another embodiment, a context electronic device 108 may be in communication with an electronic device having a sentiment tracking application 112. Sentiment analysis may involve performing natural language processing, text analysis, facial recognition, voice recognition, audio analysis and/or the like on one or more communications to extract subjective information about the communications such as, for instance, tone or demeanor. For instance, sentiment analysis may be performed to determine or estimate a customer's level of satisfaction with a communication. In an alternate embodiment, a context electronic device 108 may be in communication with an electronic device that performs sentiment analysis.

In certain embodiments, a user electronic device 102a-N may interface with a host electronic device 116. A host electronic device may be a web server or other electronic device. In an embodiment, a user may access a web application 118 associated with the host electronic device 116 via a web browser. For instance, a user may use a user electronic device 102a-N to access a web page associated with a vendor that is hosted by a host electronic device 116.

In certain embodiments, a web application 118 may send browsing information to a context electronic device 108. Browsing information may be information pertaining to the web page(s) accessed by a user such as, for example, the pages visited, information accessed, a duration of a page visit and/or the like. In certain embodiments, a web application 118 may send browsing information at regular intervals, periodically, upon request from a context electronic device 108 and/or the like.

In an embodiment, a contact center electronic device 106a-N may be associated with a contact center for a vendor, organization, entity and/or the like. Contact center representatives such as, for example, phone representatives, may use a contact center electronic device to obtain information about a particular user, session and/or the like. A customer who initiates a communication over a phone line may reach a customer center representative associated with a contact center.

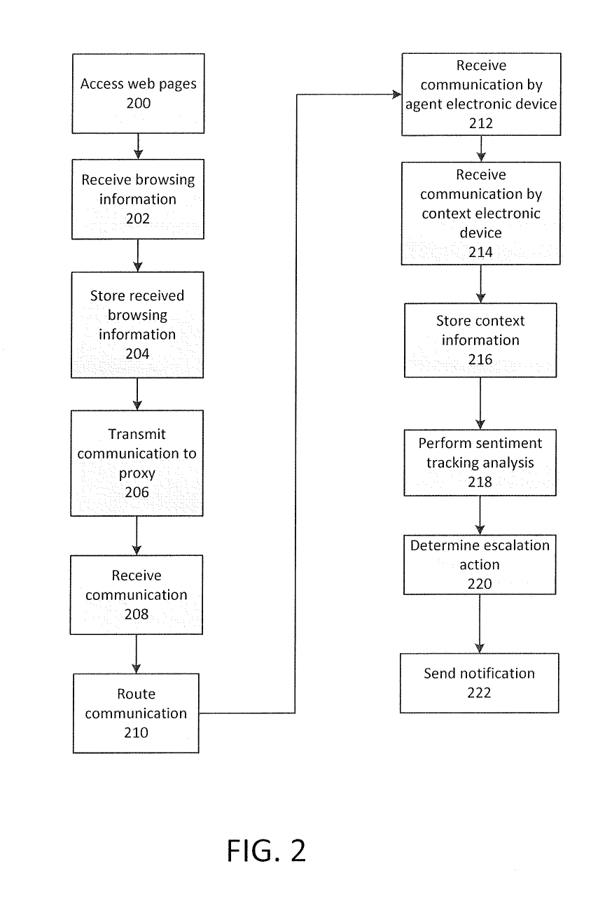

FIG. 2 illustrates an example method of communication with a multi-channel communication system according to an embodiment. As illustrated by FIG. 2, a user may access 200 one or more web pages via a user electronic device. Browsing information pertaining to a user's browsing session may be sent by a web application to a context electronic device. In an embodiment, a web application may send browsing information to a context electronic device at regular intervals, periodically, upon request and/or the like.

A context electronic device may receive 202 browsing information, and may store 204 the browsing information in a session database. A context electronic device may recognize a user identifier associated with a user, and may store 204 the received browsing information in an entry of the session database associated with the user. For instance, a context electronic device may recognize an Internet Protocol (IP) address or other unique identifier of the user associated with the browsing information, and may store the browsing information in an entry of the session database that is associated with the user. For example, a customer may access a website to buy a pair of shoes. The user may browse various pages of the website, may perform a search of inventory and/or the like. For instance, a customer may search for black flat shoes, and may view pages associated with two different pairs. She may view a page associated with a first pair of shoes three times, and a page associated with a second pair of shoes two times. A web application that is monitoring the customer's browsing activities may send this browsing information to a context electronic device, which may in turn store 204 the received browsing information in a session database such that it is associated with the customer.

During the customer's browsing session, she may have a question pertaining to a pair of shoes. For instance, she may need assistance purchasing the shoes, may have a question about sizing and/or the like. The customer may initiate a communication via a user electronic device. The communication may be any applicable format of such as, for instance, a chat message, an email message, a video chat session, a web browser session, a screen sharing session, a social media post or communication and/or the like.

A user electronic device may transmit 206 a communication to a proxy. In an embodiment, a proxy may receive 208 the communication, and may route 210 it to one or more agent electronic devices and/or a context electronic device. For instance, a proxy may receive 208 a chat message from a user electronic device, and may route 210 the communication to an agent electronic device of an agent who handles chat messages, but may also route 210 a copy of the communication to a context electronic device.

An agent electronic device may receive 212 a communication and an agent associated with the agent electronic device may work to answer the user's question, issue or concern, such as, for example, by responding via the initiated chat session.

A context electronic device may receive 214 a routed communication, and may store 216 context information pertaining to the receive communication in a session database. A context electronic device may recognize a user identifier associated with a user, and may store 216 context information for the received communication in an entry of the session database. For instance, context information may include a unique identifier associated with the initiating user such as, for example, the user's name, a username or screen name, a phone number, an IP address, or other unique identifier. A context electronic device may obtain a user identifier and may store 216 context information in the session database such that it is associated with the user identifier.

Referring to the above example, the customer who is interested in purchasing a pair of shoes may initiate a chat session with a live chat agent to figure out what size is the best fit. The chat session may be implemented over a communication network between the customer's user electronic device and the live chat agent's agent electronic device. But a proxy may transmit the chat session to a context electronic device, which may store context information pertaining to the chat session in a session database.

As another example, a user who initiates a phone call communication may speak with an agent at a contact center. An agent may record notes or other information about the phone session via a contact center electronic device. These notes and/or a copy of the audio stream of the call may be sent to a context electronic device, which may store such information in a session database.

In various embodiments, a context electronic device may maintain a rules database pertaining to communications. A rules database may include information for mapping one type of communication to one or more other types of communications. For instance, a rules database may include one or more rules for mapping chat sessions to phone calls, email communications to chat sessions, and/or the like. As an example, a unique identifier associated with a chat session of a user may be mapped to a phone number for the user. In various embodiments, this mapping may be based on information collected from a user and/or previous user communications. Additional and/or alternate mappings may be used within the scope of this disclosure.

A context electronic device may use one or more rules to store information about one or more of the user's communications in session database entries that are associated with the user. As such, a session database may maintain a global view of a user's sessions, regardless of what communication channel was used.

In an embodiment, a sentiment tracking application may perform 218 sentiment tracking analysis on at least a portion of context information stored in a session database of a context electronic device. A sentiment tracking application may refer to a set of programming instructions that, when executed by a processor of an electronic device, performs sentiment analysis on data. Sentiment analysis may involve performing natural language processing, text analysis, facial recognition, voice recognition, audio analysis and/or the like on one or more communications to extract subjective information about the communications such as, for instance, tone or demeanor. For instance, sentiment analysis may be performed to determine or estimate a customer's level of satisfaction with a communication. A sentiment tracking electronic device may determine a level of satisfaction based on words used, phrasing, facial patterns, voice tone and/or the like and/or a frequency or duration associated with the same. For example, the use of the words “unhappy” or “supervisor” during a chat session may indicate that a customer has a low satisfaction level. As another example, a chat session that occurs for more than a threshold period of time such as, for example, five minutes, may be an indication of a low level of satisfaction.

In response to determining through sentiment analysis that a user has a low satisfaction level, a context electronic device may determine 220 an escalation action. An escalation action may be a recommendation for a different mode of communication, communication with a different agent or representative and/or the like.

For instance, referring to the above example, the customer inquiring about shoe sizes may feel like she is not obtaining the answer she needs. Sentiment analysis being performed on the context information associated with her chat session may indicate, based on phrasing, words used, and/or the like, that the user has a low satisfaction level with the communication. A context electronic device may determine 220 an escalation action of generating a recommendation that the customer speak (over voice communication) with a topic expert, such as, for instance, a sizing expert.

In an embodiment, a context electronic device may evaluate a contact center's workload when determining an escalation action. For instance, a context electronic device may access a load database, such as one that is stored by a contact center electronic device. A load database may include information about workload for one or more agents of the contact center. For instance, a load database may provide a real-time indication of how loaded or busy a queue is for a particular contact center agent. As an example, a contact center agent who handles phone calls may have an associated queue of calls that are awaiting handling by the agent.

In an embodiment, a context electronic device may determine an escalation action based on what action has the quickest resolution timeframe. For example, if an escalation action involves connecting a customer with an agent over a voice communication, a context electronic device may determine which agent will be available to speak with the customer the soonest. Referring to the above example, an escalation action may be to connect the customer with a sizing expert over a voice communication. The context electronic device may access a load database to determine the most lightly loaded queue serviced by a sizing expert. The context electronic device may generate a notification that includes one or more instructions for contacting the identified sizing expert.

In an embodiment, a context electronic device may send 222 a notification of the determined escalation action to a current agent. For instance, in the above example, a context electronic device may send a notification such as, for example, via a different chat session, to the live chat agent handling the customer's chat session recommending that the live chat agent connect the customer with the sizing expert having the shortest queue of calls over a voice communication. The notification may include one or more instructions for implementing the escalation action. For instance, in the above example, the notification may include a web page, a hyperlink, or a uniform resource locator (URL) to present to the user through which the user can initiate a voice communication with the recommended sizing expert. As another example, the notification may include a direct dial number through which the user may initiate a voice communication.

The agent currently servicing a user may convey the recommended escalation action to the user, and the user may then initiate the recommendation escalation action. For instance, in the above example, the live chat agent assisting the customer may notify the customer, via the chat session, that the customer can speak with a sizing expert by accessing a specific web page, and may provide the customer with instructions about accessing the web page. The customer may initiate a communication with the sizing expert by following the instructions.

In an embodiment, when an agent who is assigned an escalation action receives a communication from the customer, the agent may query the session database of a context electronic device using an electronic device to obtain information pertaining to the customer's session history. For instance, in the above example, the customer may initiate a voice call with a sizing agent at a contact center. The sizing agent, upon receiving the voice communication, may use an electronic device, such as, for example, a contact center electronic device, to search a session database of a context electronic device for information about the customer's previous experiences. The agent may search the database using one or more search criteria such as, for example, the user's unique identifier, a chat session identifier, a user's phone number and/or the like. As a result, the agent may be able to access the customer's browsing information, previous chat sessions with the live chat agent, notes about the session from the live chat agent and/or the like.

In various embodiments, any agent, regardless of the communication channel that the agent supports, may be able to obtain session information for one or more users by accessing a session database of a context electronic device. For instance, if the customer in the above example decides that she needs additional help the day after speaking with the sizing expert, she may initiate a subsequent communication with an agent. For example, she may initiate a communication over a social media platform. The agent handling social media platform communications may query a session database to access the customer's browsing information, chat sessions with the live chat agent, notes about the session from the live chat agent, audio from the customer's voice communication with the sizing expert, notes from the sizing expert about the communication and/or the like. As such, the customer does not need to explain her past interactions or dealings with the contact center, which may make the customer engagement process more efficient and customer-friendly.

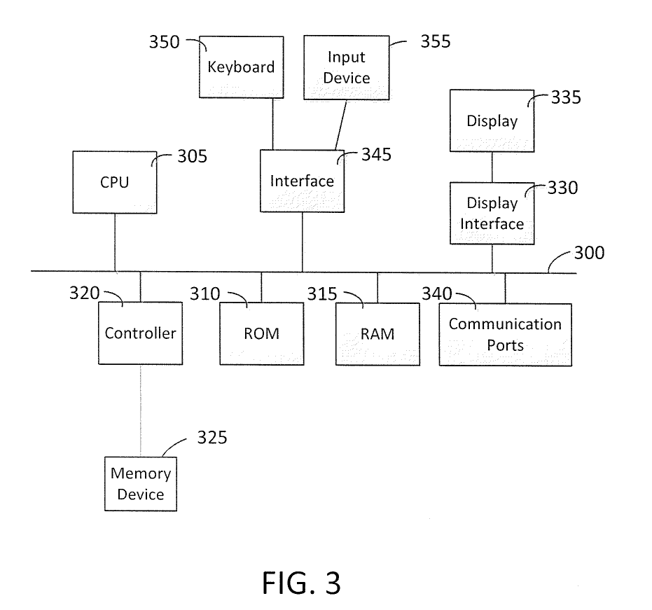

FIG. 3 depicts a block diagram of hardware that may be used to contain or implement program instructions. A bus 300 serves as the main information highway interconnecting the other illustrated components of the hardware. CPU 305 is the central processing unit of the system, performing calculations and logic operations required to execute a program. CPU 305, alone or in conjunction with one or more of the other elements disclosed in FIG. 3, is an example of a production device, computing device or processor as such terms are used within this disclosure. Read only memory (ROM) 310 and random access memory (RAM) 315 constitute examples of non-transitory computer-readable storage media.

A controller 320 interfaces with one or more optional non-transitory computer-readable storage media 325 to the system bus 300. These storage media 325 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 310 and/or the RAM 315. Optionally, the program instructions may be stored on a tangible, non-transitory computer-readable medium such as a compact disk, a digital disk, flash memory, a memory card, a USB drive, an optical disc storage medium and/or other recording medium.

An optional display interface 330 may permit information from the bus 300 to be displayed on the display 335 in audio, visual, graphic or alphanumeric format. Communication with external devices, such as a printing device, may occur using various communication ports 340. A communication port 340 may be attached to a communications network, such as the Internet or an intranet.

The hardware may also include an interface 345 which allows for receipt of data from input devices such as a keyboard 350 or other input device 355 such as a mouse, a joystick, a touch screen, a remote control, a pointing device, a video input device and/or an audio input device.

It will be appreciated that the various above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

What is claimed is:

1. A multi-channel communication system comprising:
a plurality of agent electronic devices associated with a customer center;
a context electronic device comprising a processor and a session database, wherein the context electronic device is in communication with each of the plurality of agent electronic devices such that each of the plurality of agent electronic devices is able to access information stored in the session database; and
a proxy in communication with one or more user electronic devices and the context electronic device, wherein the proxy is configured to route a communication from the user electronic devices to:
a designated agent electronic device from the plurality of agent electronic devices that is associated with a communication channel, wherein the communication occurs via the communication channel, and
the context electronic device,
wherein the context electronic device is configured to store received context information associated with the communication in the session database.

2. The multi-channel communication system of claim 1, wherein the context electronic device is configured to:
receive browsing information associated with a web page session initiated by a user of the user electronic device;
map the browsing information to the context information; and
store the received browsing information in an entry of the session database associated with the user.

3. The multi-channel communication system of claim 1, wherein the context electronic device comprises a sentiment tracking application, wherein the context electronic device is further configured to perform sentiment tracking analysis on at least a portion of the context information.

4. The multi-channel communication system of claim 3, wherein the context electronic device is further configured to:
determine, based on the sentiment tracking analysis, if a user satisfaction level is low; and
in response to determining that the user satisfaction level is low, determine an escalation action.

5. The multi-channel communication system of claim 4, wherein the context electronic device is further configured to determine an escalation action by:
accessing a load database associated with a contact center, wherein the load database comprises information about pending service requests associated with one or more agents of the contact center;
identifying an agent having a fewest number of pending services requests; and
generating one or more instructions for contacting the identified agent.

6. The multi-channel communication system of claim 5, wherein the context electronic device is further configured to send a notification to the designated agent electronic device, wherein the notification comprises the one or more instructions.

7. The multi-channel communication system of claim 1, wherein the communication comprises one or more of the following:
a live chat communication;
a video chat communication;
an electronic mail communication;
a text message communication; and
a social media communication.

8. The multi-channel communication system of claim 1, wherein the context electronic device is further configured to:
receive second context information associated with a second communication of the user electronic device, wherein the second communication occurs via a second communication channel that differs from the communication channel;
map at least a portion of the second context information to at least a portion of the context information; and
store the second context information in a record of the session database such that the record is associated with the context information.

9. The multi-channel communication system of claim 1, further comprising a contact center electronic device in communication with the context electronic device, wherein the contact center electronic device is configured to query the session database.
